(19) United States
(12) Patent Application Publication
(10) Pub. No.: US 2006/0125261 A1
(43) Pub. Date: Jun. 15, 2006

(54) Multi-layered trolley wheel

(76) Inventors: Po-Jen Shih, Webster, NY (US); Cheryl Smithers, Rochester, NY (US); Zhanjun Gao, Rochester, NY (US)

Correspondence Address: Pamela R. Crocker;Patent Legal Staff, Eastman Kodak Company, 343 State Street, Rochester, NY, 14650-2201, US

(21) Appl. No.: 11/011,819

(22) Filed: Dec. 14, 2004

(51) Int. Cl. B60B 17/00

(52) U.S. Cl. 295/1

(57) ABSTRACT

A wheel has a metallic hub with a circumferential surface. A first layer formed of a compliant material surrounds the outer circumferential surface, and a second layer surrounds the first layer. The compliant material has a modulus of elasticity of between about 1 MPa and about 10,000 MPa, and the second layer has a modulus of elasticity between about 10,000 and about 210,000 MPa. The first layer provides compliance and the second layer provides impact resistance to inhibit wear of the wheel thereby minimizing production of metallic contaminants.

### FIELD OF THE INVENTION

The invention relates generally to wheels for manufacturing equipment that move heavy loads in a trolley system. More specifically, the invention relates to wheels for monorail trolley systems that are used to convey rolls of webs from one place to another on a production floor in a manufacturing environment that must be contamination free.

### BACKGROUND OF THE INVENTION

In a photographic film manufacturing environment contaminants such as dust and debris from the material conveying system must be strictly controlled, especially during the final stage when photographic emulsions are applied to produce the photographic film. Extreme care must be taken to ensure that the final product is clean and defect free. Furthermore, extreme caution must be taken to ensure that photoactive particles do not contaminate the film. Iron and iron compounds, aluminum and silicone are examples of photoactive contaminants. It takes less than ten parts per million of iron deposited on photographic film to have a noticeable photographic effect. Unfortunately, there are many moving and stationary components in a monorail system that contain iron. Wear debris and corrosion products of those components are a source of detrimental iron and iron compounds. The largest amounts of iron debris are produced when the steel wheels of trolleys traverse the stationary monorail track at a speed greater than 30 feet per minute. Although extreme care is taken to clean the wheels, tracks and other components of monorail trolleys, it is difficult to completely eliminate contamination.

Iron contamination can be minimized by switching to non-metallic trolley wheels; however, it is difficult substitute for steel with other engineering materials cost effectively without sacrificing robustness. U.S. Pat. No. 5,658,030 discloses a poly amide-imide clad roller comprising a stainless steel hub portion and a cast poly amide-imide cover supported by the stainless steel hub. The poly amide-imide clad roller is useful for trolley wheels and guide rollers of a monorail trolley system, and reduces debris originated from trolley wheels and guide rollers, particularly in the environment of producing iron sensitive photographic materials.

Unfortunately, durability problems exist with the poly amide-imide clad trolley wheels and guide rollers in trolley systems in the manufacturing environment. The trolley system has to carry heavy loads and travel at speeds greater than 30 feet per minute over the stationary rails from one location to another on the production floor. The poly amide-imide clad trolley wheels and guide rollers are subjected to very stressful conditions because of the severe impact forces incurred at the gaps between rails and sharp comers. These concentrated stresses often result in chipping or breaking of the poly amide-imide clad trolley wheels creating dust and debris. The steel portion of a wheel can be exposed when there is severe chipping causing iron contamination. Thus, there is a need for a wheel that is durable but contributes minimally to iron contamination in a photographic film manufacturing environment.

### SUMMARY OF THE INVENTION

The present invention is directed to overcoming one or more of the problems set forth above. Briefly summarized, according to one aspect of the present invention, metallic contamination to photographic film base can be prevented in the production environment by providing, and using on material transporting equipment, trolley wheels each of which comprises: a metallic hub having an outer circumferential surface; a first layer surrounding the outer circumferential surface and formed of a compliant material having a modulus of elasticity of between about 1 MPa and about 10,000 MPa; and a second layer surrounding the first layer and having a modulus of elasticity between about 10,000 and about 210,000 MPa. The first layer provides compliance and the second layer provides impact resistance to inhibit wear of the wheel thereby minimizing production of metallic contaminants.

Constructing the multiple layered trolley wheels and guide rollers so that the polymeric inner layer provides some compliance to form a larger nip reduces the stress concentration, and the thin metallic outer layer provides protection for the inner compliant polymeric layer under impact loading conditions. With this unique combination, the wear rate of the rail and wheels is reduced thereby reducing the metallic contaminants. Having a smaller amount of iron contaminants not only reduces production waste but also minimize the number of trolley system services required per year that easily convert to higher productivity and significant cost saving. In addition, no special costly treatment or modification of the track system is required, and the cost of manufacturing such wheels and rollers is insignificant compared to extensive cleaning efforts and facility down time heretofore suffered.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is a diagrammatic view of a monorail carrier with portions of a wheel and roller in cross-section illustrating a steel hub with first and second layers according to the resent invention;

FIG. 2A is a diagrammatic cross-section of a prior art wheel with TORLON polymer cladding on a steel hub;

FIG. 2B is a diagrammatic cross-section of a prior art wheel with poly amide-imide cladding on a steel hub;

FIG. 3 is a schematic diagram of a multi-layered trolley wheel illustrating parameters for a contact pressure calculation;

FIG. 4 is a schematic diagram of a multi-layered trolley wheel illustrating a set-up for a compression test;

FIG. 5 is a graph illustrating compression test results; and

FIG. 6 is a graph of calculated width (mm) vs. load (N).

### DETAILED DESCRIPTION OF THE INVENTION

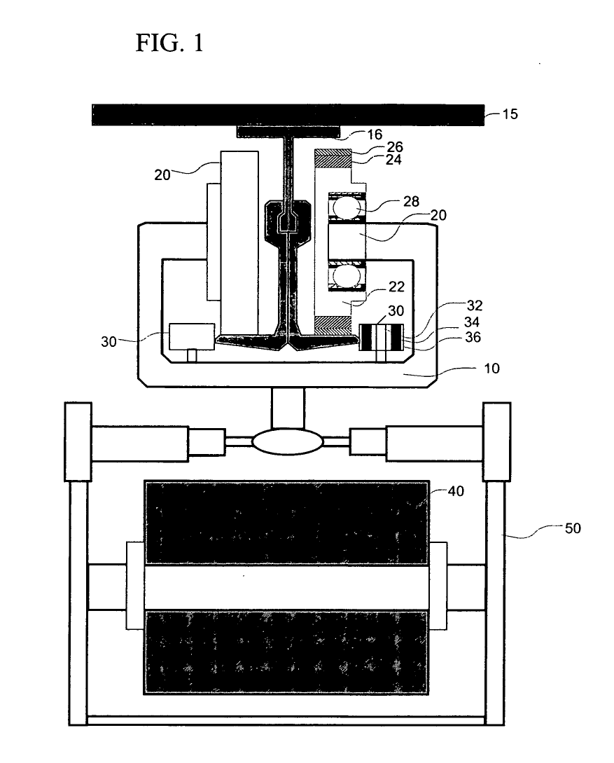

Referring to FIG. 1, a monorail carrier system comprises an overhead monorail trolley 10 which rides on a steel beam assembly 16 anchored on the ceiling 15. The monorail trolley system 10 is equipped with multi-layered trolley wheels 20 and guided by multi-layered guide rollers 30. Monorail trolley 10 has a steel carrier 50 that is adjustable and can carry acetate or other polymeric rolls 40 of various diameters. The loaded monorail trolley can be moved manually from one station to another on the production floor.

Each multi-layered trolley wheel 20 has a rigid hub 22 with a circumferential surface. A bearing unit 28 is centrally disposed in a central opening or cavity of wheel 20 and rides on a protruding potion of monorail trolley 10 which functions as an axle. A first compliant layer 24 surrounds the circumferential surface of hub 22 and preferably has a modulus of elasticity between about 1 Mpa and about 10,000 Mpa. A second layer 26 surrounds the circumference of first compliant layer 24 and preferably has a modulus of elasticity between about 70,000 Mpa and about 210,000 Mpa. Trolley wheel 20 is mounted on a protruding portion of monorail trolley 10.

Similarly, multi-layered guiding roller 30 has a rigid hub 32 with a circumferential surface. A first compliant layer 34 surrounds the circumferential surface of hub 32 and preferably has a modulus of elasticity between about 1 Mpa and about 10,000 Mpa. A second layer 36 surrounds the circumference of first compliant layer 34 and preferably has a modulus of elasticity between about 10,000 Mpa and about 210,000 Mpa. Guide roller 30 is mounted on a protruding portion of monorail trolley 10, which functions as an axle.

The rigid hubs 22, 32 may be made of metals with high elastic modulus and strength such as steel, preferably high strength stainless steel. First compliant layers 24, 34 may be made from an elastomeric compound or engineering thermoplastic that has an elastic strain limit no less than 2 percent and preferably no less than 5 percent. Elastomeric compounds may include polyurethane; natural rubber, silicon and fiber reinforced elastomeric composites. The engineering thermoplastics may include nylon, TORLON polymer (a poly amide-imide, TORLON is a registered trademark of Amoco Chemicals Corp.), and other high performance engineering thermoplastics.

The first compliant layers 24, 34 may be capable of providing compliance when the multi-layered trolley wheels and rollers are subjected to heavy loads. As a result, multi-layered trolley wheel 20 with first compliance layer 24 provides a wider contact area that better distributes the load. A wider contact area reduces contact pressure, which is one of the major contributors to wear, and thus contamination which is undesirable.

The second layers 26, 36 of the multi-layered trolley wheels and guide rollers comprise a thin, wear resistant, stiff material such as high strength stainless steel, nickel, titanium or filament wound fiber reinforced composites. The second layers are capable of withstanding high impact loading and provide wear resistance. The second layer can be constructed of a composite material or thermosetting matrix with strengthening fibers incorporated therein for durability. Strengthening fibers within the scope of the invention include, but are not limited to, polybenzimidazole (PBI), polyphenylene-2,6-benzobisoxazole (PBO), modacrilic, p-aramid, m-aramid, polyvinyl halides, polyesters, nylons, rayons, and melamine. Preferably, the fibers are p-aramids, such as KEVLAR, or m-aramids, such as NOMEX, (KEVLAR and NOMEX are registered trademarks of E. I. DuPont de Nemours and Company).

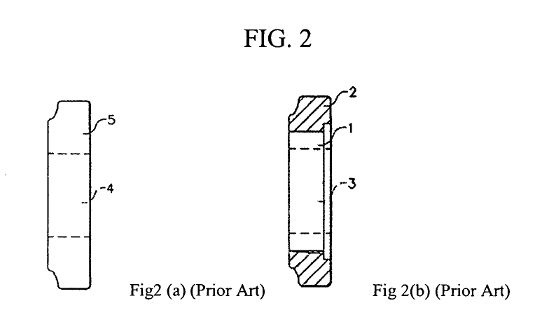

FIG. 2A shows the construction of a prior art steel wheel 5 with a ball bearing 4. FIG. 2B shows the construction of a prior art clad trolley wheel with a steel hub 1, a TORLON polymer clad layer 3 and a ball bearing 2.

### EXAMPLE 1

A trolley wheel according to the present invention has a steel hub 91.4 mm in diameter and 17 mm in width. A first layer of polyurethane is 4.3 mm thick, has a density of 1.1 gm/cm³, a modulus of elasticity between 1 and 100 Mpa, and a hardness of shore A of 20° to 95°. A 0.76 mm thick prefabricated of high strength stainless steel is bonded onto the first polyurethane layer.

### EXAMPLE 2

A trolley wheel according to the present invention has a steel hub 94 mm in diameter and 17 mm in width. A first 3.05 mm thick layer of polyurethane having a density of 1.1 gm/cm³, a modulus of elasticity of about 200,000 Mpa, and a shore A of 20° to 95° is attached to the wheel. A second 0.76 mm thick prefabricated layer of high strength stainless steel having a modulus of elasticity of about 200,000 Mpa and a yield strength in a range of about 500 Mpa to about 2,500 Mpa is bonded onto the first polyurethane layer.

### EXAMPLE 3

A 17 mm wide trolley wheel according to the present invention has a steel hub 66.55 mm in diameter. A first 16.76 thick layer of TORLON polymer having a specific gravity of from about 1.40 to 1.41, a tensile strength at 73° F. of from about 110 Mpa to about 150 Mpa, a percent elongation at 73° F. of from about 5 to about 18, and a Rockwell hardness at 73° F. of from about M114 to about M124 is attached to the wheel. A second 0.76 mm thick prefabricated layer of high strength stainless steel having a modulus of elasticity of about 200,000 Mpa and yield strength of about 500 Mpa to about 2,500 Mpa is bonded onto the first TORLON polymer layer.

### COMPARATIVE EXAMPLE 4

A prior art steel trolley wheel was built for comparison with the present invention as described in examples 1-3. As shown in FIG. 2A, a 17 mm wide trolley wheel was built with an AISI 316 stainless steel 100.1 mm in diameter.

### COMPARATIVE EXAMPLE 5

A prior art steel trolley wheel with a TORLON polymer ring as the outer layer was built for comparison with the present invention as described in examples 1-3. As shown in FIG. 2B, a 17 mm wide trolley wheel was built with an AISI 316 stainless steel hub 66.55 mm in diameter and an outer 17.53 mm thick layer of TORLON polymer having a specific gravity of from about 1.40 to about 1.41, a tensile strength at 73° F. of from about 112 Mpa to about 150 Mpa, a percent elongation at 73° F. of from about 5 to about 18, and a Rockwell hardness at 73° F. of from about M114 to about M124.

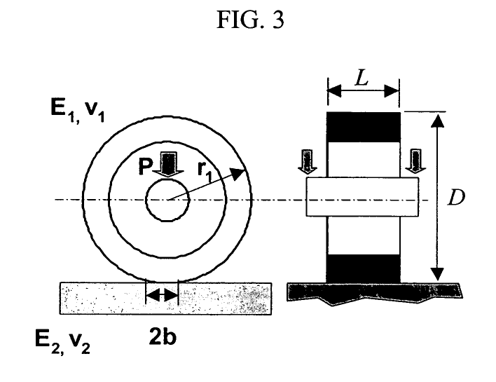

The basic issue addressed is how to significantly reduce iron contamination that comes mainly from debris of wear from the steel components. Although there is no definitive law of wear, for trolley systems it is reasonable to say that wear increases with operating time and is influenced by factors such as surface hardness, contact pressure, nominal area of contact and speed. Wear exhibits a general characteristic that below a certain load the wear is minimal, and above that load wear rises catastrophically by a factor that may be 1,000 or even 10,000 times greater. Examining the wear debris and the failed steel wheel surface reveals very high contact stress between the steel wheel and steel track as one of the major wear mechanisms. Based on the theory of elasticity, the contact stress or contact pressure is directly proportional to the compressive force and inversely proportional to the contact area as follows (FIG. 3): The maximum contact stress,

$${σ}_{c} = \frac{2 P}{π bL} , \\ where$$

$$b = {[ \frac{4 {Pr}_{1}}{π {LE}^{*}} ]}^{\frac{1}{2}}$$

is half the contact nip width and effective modulus,

$${E}^{*} = {[ \frac{1 - {v}_{1}^{2}}{{E}_{1}} + \frac{1 - {v}_{2}^{2}}{{E}_{2}} ]}^{- 1} ,$$

and where L₁ and r₁ are the width and radius of the trolley wheel, E₁, v₁ are the Young's modulus and Poisson's Ratio of the roller material, respectively, and E₂, v₂ are the Young's modulus and Poisson's Ratio of the steel track, respectively.

Compressive force P is determined by the weight of photographic support rolls that the trolley has to carry from one location to another. To minimize σ the contact stress, a superior trolley wheel has to provide a larger contact area and simultaneously hold its integrity under various severe loading conditions including impact during maneuvering through sharp comers on the production floors.

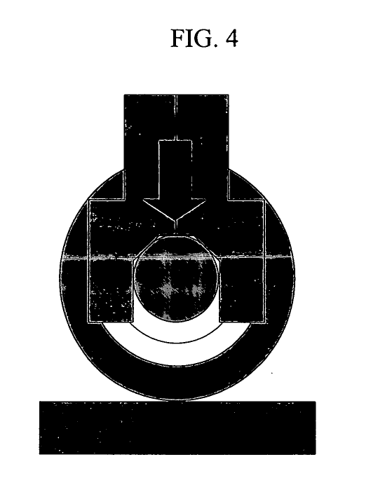

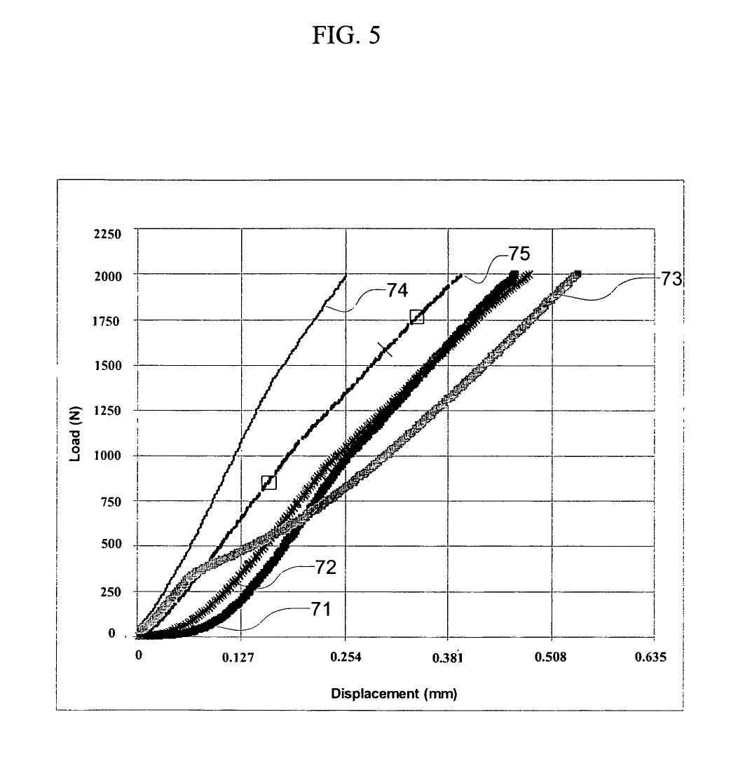

Experiments and contact stress calculations were performed on the present invention (EXAMPLES 1-3) along with prior art wheels (COMPARATIVE EXAMPLES 4-5) to determine performance. FIG. 4 depicts the experimental schematic while FIG. 5 shows the experimental results (load vs. displacement curve).

In FIG. 5 curves 71, 72 and 73 respectively illustrate compression test results for the layered trolley wheels of Examples 1, 2 and 3. Curve 74 shows compression test results for the steel trolley wheel of Example 4. Similarly, curve 75 shows test results for the TORLON polymer clad trolley wheel of Example 5.

The compressive test results show that all trolley wheels can withstand static loading conditions and pass visual inspection of surface integrity. EXAMPLE 1 and 2 wheels behaved similarly suggesting that the effect of thickness of the first layer polyurethane, at the range used, is insignificant.

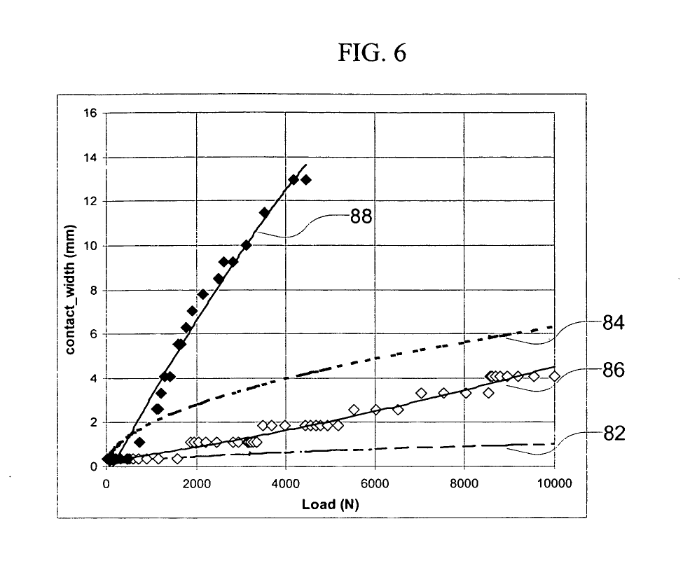

FIG. 6 shows the external loading (N) vs. contact width. EXAMPLE 4 prior art steel trolley wheel has a very small contact area, thus very high stress concentration as shown by curve 82. Because the steel rollers are in point and line contact with the track, load acts on a very small area. Sever stress concentration causes surface wear on the steel wheels as well as the track that produces a significant amount of iron debris. Though the wear stress limit of the steel might be high compared to other trolley wheels made of plastic materials, it has nevertheless caused severe iron contamination problems in the production line.

The polymer clad trolley wheels of EXAMPLE 5 have a larger contact are, thus lower stress concentration as shown by curve 84. However, the polymer clad trolley wheel failed in the life test. Looking closer at the wear and failure modes of both steel and polymer clad steel wheels, we can see that steel and polymer clad steel failed differently. Polymer clad wheels failed in fracture mode due to insufficient fracture toughness. The sharp edge o the track cut into the polymer clad wheel and consumed a small chunk of the polymer during impact. Soon after the first score appeared, the catastrophic failure followed. To this end, it is quite obvious that polymer clad wheels are not a satisfactory solution to the problem of metallic contamination of the monorail trolley system.

As shown by curve 86 in FIG. 6, the trolley wheel of EXAMPLE 3 provides more contact area and the outer steel layer provides protection to prevent chipping of the polymer. EXAMPLE 1 and 2 trolley wheels provide the largest contact area to keep the contact stress below the wear stress limit as shown by curve 88. Although the EXAMPLE 1 and 2 trolley wheels still have a contact surface of steel to steel with the rail tracks, the wear was minimum. These excellent results have been confirmed by life tests where the wheels were placed in the production environment. During the life test, the wheels were also subjected to a sharp edge at a speed of 30 ft per minute with no sign of chipping or cracking. It is believed that the first layer of polyurethane provides compliance and yields a larger contact area thus easing out contact stress concentration. It is believed that the second of steel provides impact resistance and protects the first compliant layer of polyurethane. It is this unique combination of the material properties that provide a satisfactory solution to metallic contamination problems of the monorail systems.

While the present invention has been specifically directed for use in conjunction with production of photographic emulsions where reduction/elimination of metal debris is very important, it is to be understood that the invention may be used in other production floor environments where heavy loads are carried from one work station to another and there is a problem with wheel wear and consequent debris. The invention has been described with reference to the preferred embodiments; However, it will be appreciated that variations and modifications can be effected by a person of ordinary skill in the art without departing from the scope of the invention.

### PARTS LIST

1 steel hub
2 cast TORLON polymer cladding
3 ball bearing
4 ball bearing
5 steel wheel
10 an overhead monorail trolley
15 ceiling
16 steel I-beam anchored on the ceiling
20 multi-layered trolley wheels
22 rigid hub and bearing assembly
24 compliant layer
26 impact resistant layer
28 bearing unit
30 cast polyurethane guide roller
32 rigid hub
34 first compliant layer
36 second layer
40 roll of web material
50 steel carrier
71 compression test results for Example 1 layered trolley wheel
72 compression test results for Example 2 layered trolley wheel
73 compression test results for Example 3 layered trolley wheel
74 compression test results for Example 4 steel trolley wheel
75 compression test results for Example 5 TORLON polymer clad wheel
82 nip contact width calculated results for Example 4 steel trolley wheel
84 nip contact width calculated results for Example 5 TORLON polymer trolley wheel
86 nip contact width calculated results for Example 3 layered trolley wheel
88 nip contact width calculated results for Example 1 layered trolley wheel

What is claimed is:

1. A wheel, comprising:
a metallic hub having an outer circumferential surface;
a first layer surrounding said outer circumferential surface and having a modulus of elasticity of between about 1 MPa and about 10,000 MPa; and
a second layer surrounding said first layer and having a modulus of elasticity between about 10,000 and about 210,000 MPa, said first layer providing compliance and said second layer providing impact resistance to inhibit wear of said wheel thereby minimizing production of metallic contaminants.

2. A wheel, as set forth in claim 1, wherein said metallic hub is steel, said first layer is an elastomeric compound and said second layer is a metal.

3. A wheel, as set forth in claim 2, wherein said metallic hub is high strength stainless steel, said elastomeric compound is polyurethane, and said second layer is high strength stainless steel.

4. A wheel, as set forth in claim 1, wherein said metallic hub is steel, said first layer is an engineering thermoplastic and said second layer is a metal.

5. A wheel, as set forth in claim 4, wherein said metallic hub is high strength stainless steel, said engineering thermoplastic is polyamide-imide, and said second layer is high strength stainless steel.

6. A wheel, as set forth in claim 1, wherein said metallic hub is steel, said first layer is an elastomeric compound and said second layer is a composite material.

7. A wheel, as set forth in claim 6, wherein said metallic hub is high strength stainless steel, said elastomeric compound is polyurethane, and said second layer is a fiber reinforced composite material.

8. A wheel, as set forth in claim 7, wherein said composite is p-arimid fibers and thermosetting matrix.

9. A wheel, as set forth in claim 7, wherein said composite layer is made of glass fibers and a thermoplastic matrix.

10. A wheel, as set forth in claim 1, wherein said metallic hub is steel, said first layer is engineering thermoplastic and said second layer is a composite material.

11. A wheel, as set forth in claim 10, wherein said metallic hub is high strength stainless steel, said engineering thermoplastic is polyamide-imide (TORLON), and said composite material is made of p-arimid fibers and a thermosetting matrix.

12. A wheel, as set forth in claim 10, wherein said metallic hub is high strength stainless steel, said engineering thermoplastic is polyamide-imide and said composite material is made of glass fibers and a thermoplastic matrix.

13. A trolley wheel, comprising:
a metallic hub having an outer circumferential surface;
an elastomeric layer surrounding said outer circumferential surface; and
a metallic layer surrounding said elastomeric layer, said elastomeric layer providing compliance and said metallic layer providing impact resistance to inhibit wear of said wheel thereby minimizing production of metallic contaminants.

14. A wheel, as set forth in claim 13, wherein said hub is high strength stainless steel, said elastomeric compound is polyurethane, and said metallic layer is high strength stainless steel.

15. A wheel, as set forth in claim 13, wherein said metallic hub is steel, said metallic layer is an engineering thermoplastic.

16. A wheel, as set forth in claim 15, wherein said metallic hub is high strength stainless steel, said engineering thermoplastic is polyamide-imide, and said metallic layer is high strength stainless steel.
